(19) United States
(12) Patent Application Publication
(10) Pub. No.: US 2016/0378830 A1
(43) Pub. Date: Dec. 29, 2016

(54) DATA PROCESSING SYSTEM AND DATA PROCESSING METHOD

(71) Applicant: ADBA S.A., Warsaw (PL)

(72) Inventors: Michal CHRZASTOWSKI, Warsaw (PL); Grzegorz PAWLAK, Warsaw (PL); Krzysztof SUROWIEC, Warsaw (PL)

(21) Appl. No.: 14/901,893

(22) PCT Filed: Jun. 29, 2015
(86) PCT No.: PCT/IB2015/054878

§ 371 Date: Dec. 29, 2015

(51) Int. Cl. G06F 17/30; G06N 99/00

(52) U.S. Cl. CPC G06F 17/30477; G06N 99/005

(57) ABSTRACT

The Invention is related to a data processing system, especially data coming from a vast geographical territory, comprising the following components:
a. Means for acquiring telemetric data,
b. Adapters for initial processing of raw data,
c. Analytical modules,
d. Access interface,
e. User interface,
characterized in that it has a common, central and integrated database.

The present Invention is also related to a data processing method, especially for data coming from a vast geographical territory, in such a system.

The invention relates to an IT system for data collection and storage; data to be collected from extensive areas often very distant from each other. The system can significantly speed up and improve quality of data processing by providing dispersed information analysis and delivering a suitable tool for market analyses based especially on telemetric data. Additionally, invention comprises a method for processing such data in such a system.

There are known IT systems, which according to a classic approach, do not have a shared database and operate independent of each other, except for integration by Web Services. Data synchronizing problem or operating on the data from different sources is encountered mainly in systems which are spread geographically, where there is no possibility to have a fast connection in a traditional way.

Because of observed need for cooperation between such dispersed systems or dispersed data processing from multiple sources and countries, a concept and structure of the system was created, which is capable to process data from different sources, create integrated analytical database on their basis, and having analysed them in analytical modules the data can be presented to a final user through an innovative graphic interface, which is an industrial design applied by ADBA S. A. partnership for patenting.

Developed structures of the dispersed system for data processing is therefore designed to facilitate data processing on multiple different markets from different countries and displaying them in an organized and user-friendly way in a presentation layer (Graphical User Interface—GUI).

The dispersed system for data processing allows to analyse data from different sources in a cloud. It means that data coming from different sources and countries can be analysed in a few places simultaneously enabling dispersed analytics. The use of this system enables analysis of data coming from different bases and their coherent presentation to an end user.

According to the invention, a data processing system, especially data coming from a vast geographical territory, comprising the following components:
a. Means for acquiring telemetric data,
b. Adapters for initial processing of raw data,
c. Analytical modules,
d. Access interface,
e. User interface,
   characterized in that it has a common, central and integrated database.

Preferably, the central integrated database operates on the basis of noSQL type of structures and typically relational MSSQL/ORACLE type of structures.

Preferably, the integrated database processing significant amounts of data, comprises an advanced database engine adapted to a fast support of extended structures, e.g. Cassandra type.

Preferably, analytical modules processing information contained in the centrally integrated database operate in a Cloud computing technology.

Preferably, the analytical modules comprise modules for predictive computing and modules for descriptive computing, of which work is coordinated by a computing engine able to perform parallel computing and comprising algorithm bases for machine learning e.g. Spark type engine.

Preferably, the analytical modules comprise drivers necessary to allow communication between data stored in noSQL and MSSQL/ORACLE type databases.

Preferably, it has an user interface, which is a graphic interface developed according to User Experience (UX) rules.

Preferably, the data processing method, especially data coming from a geographically vast territory, in the system according to the Invention characterized in that:
a) telemetric data, especially those about audience, programming schedules, are acquired by means of telemetric data acquirement,
b) data acquired in this way are processed in adapters, wherein initial data cleaning and their partial denormalization is performed with redundancy achievement,
c) initially processed data are gathered and sorted in the central database.
d) data from the central database are subsequently subjected to integration and descriptive analysis, resulting in coherent information packages related to e.g. programming schedules, viewer demographic profile, advertisements costs, which are also saved in the database,
e) further data processing is performed based on user inquiries provided through and processed by a user interface.
f) data necessary to sustain user inquiries provided through the access interface are analyzed in analytical modules,
g) analysis results are transferred through the access interface to the user interface, which displays data in appropriate forms through an electronic device used.

Preferably, analytical modules use available computational resources in optimal way by performing parallel computing coordinated by appropriate software with machine learning functions e.g. Spark type.

Preferably, integrated database and analytical modules function in a Cloud computing technology.

Preferably, data corresponding to the user enquiries transmitted through the access interface to the user interface are parameterized according to user settings, such as country, currency, scheme.

Preferably, the access interface providing communication between the user interface, analytical modules and the central database use drivers such as ODBC/JDBC, Cassandra Connector, ORACLE, MSSQL Connector, allowing fast communication between environments with different data formats.

A market data processing method according to the Invention, characterized in that entering and displaying query results are performed using a graphic user interface, preferably maintained by PCs, laptops, tablets and/or smartphones.

### PREFERRED EMBODIMENT

Preferred embodiment is presented below with a direct reference to Figures in which:

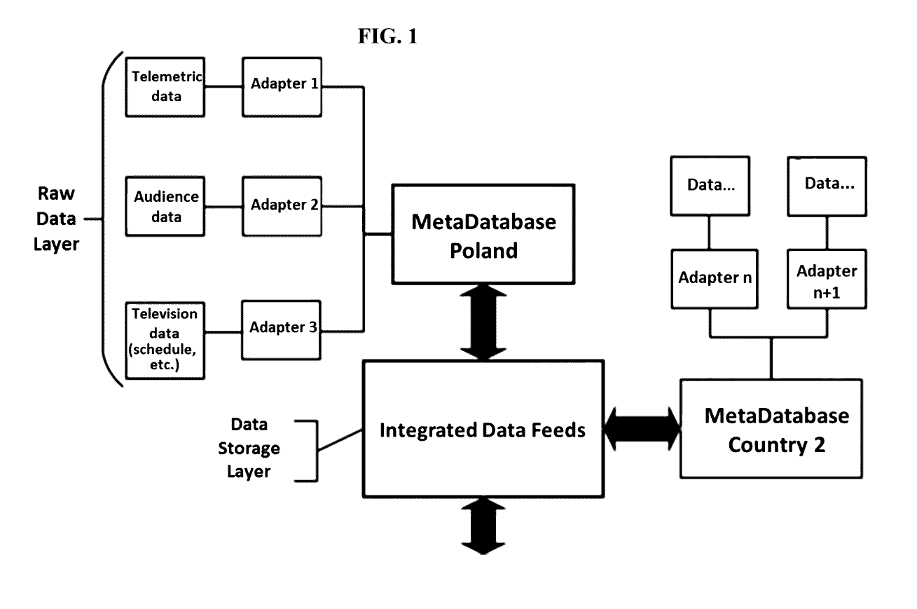

FIG. 1 presents a schematic view of raw data layer elements and their connection with a data storage layer.

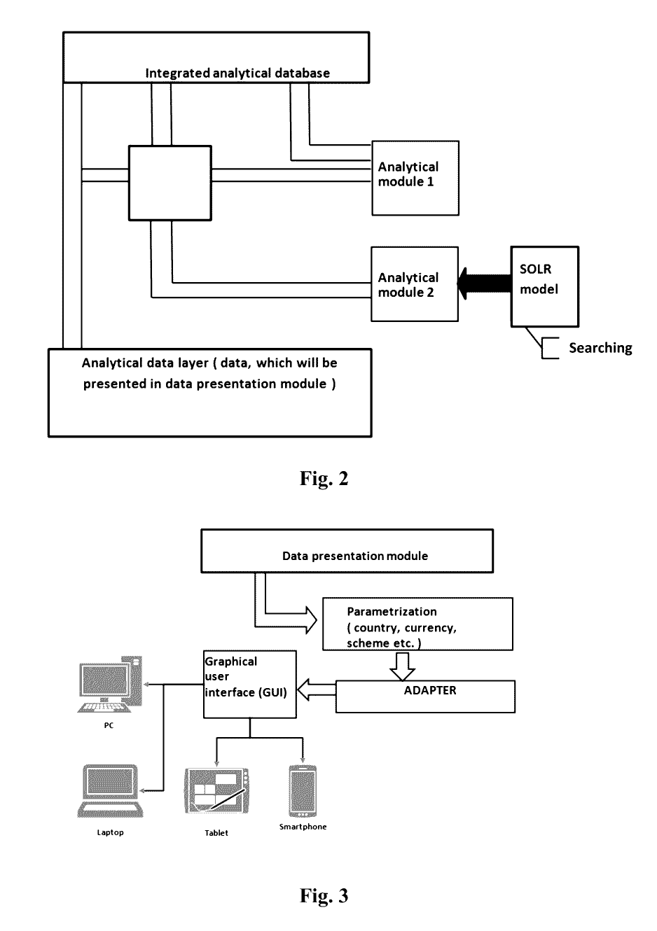

FIG. 2 presents a schematic view of analytic data layer elements and their interconnections.

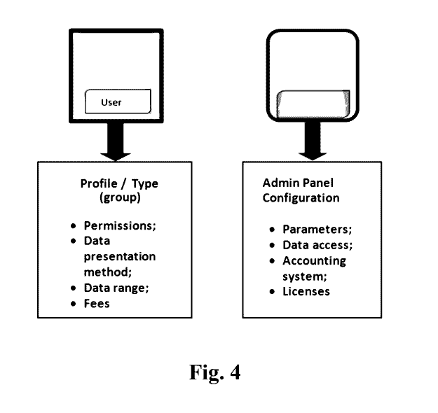

FIG. 3 presents a schematic view of elements taking direct part in presenting inquiry results to the users.

FIG. 4 presents in a schematic manner types of system users according to the Invention.

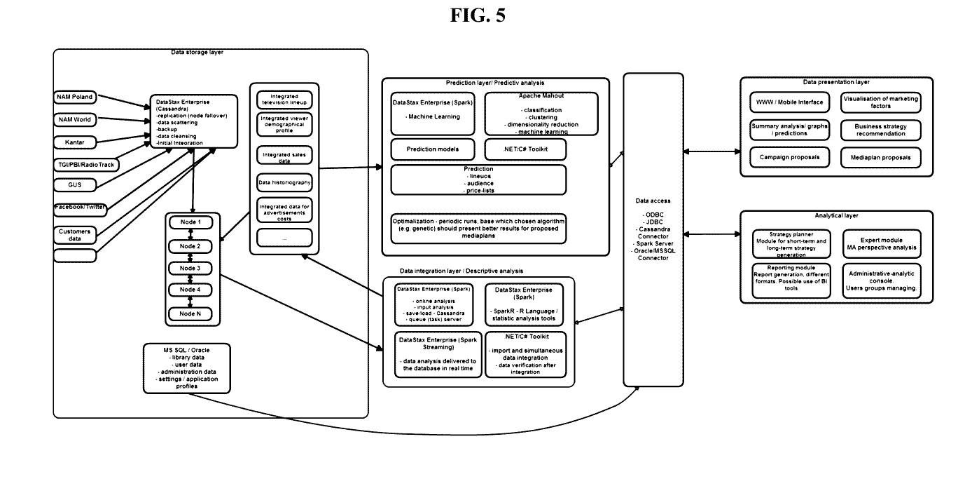

FIG. 5 presents in an illustrative manner the structure of the system and its most important elements and data flow directions.

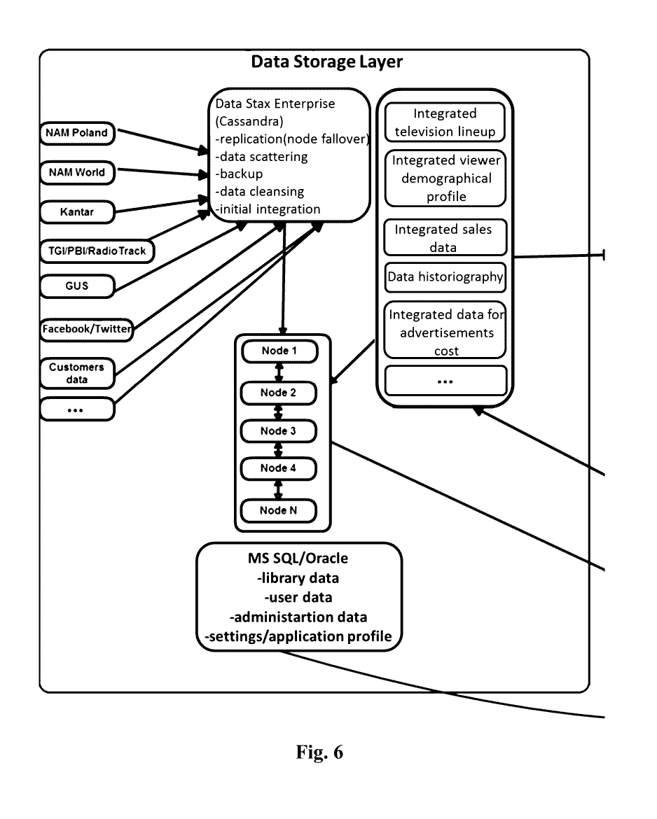

FIG. 6 presents enlarged view of FIG. 5, zooming up a part showing structure of data gathering layers.

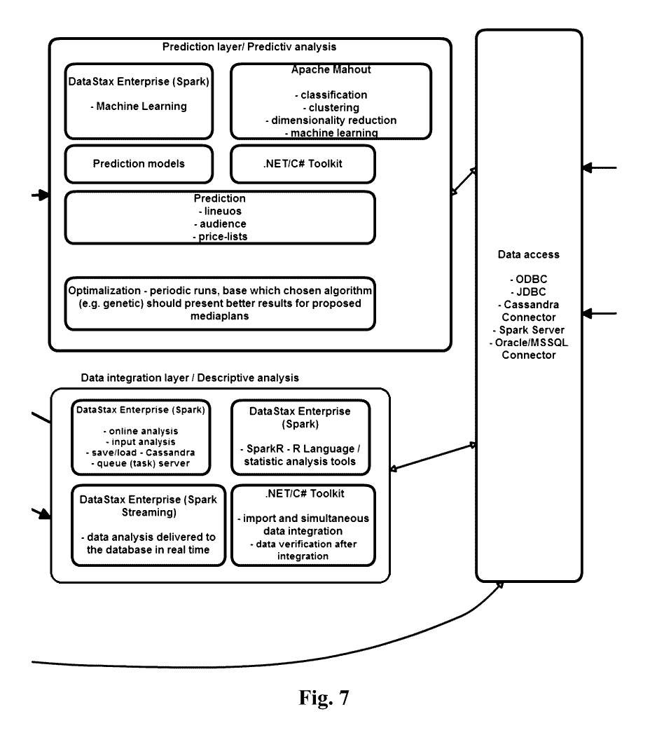

FIG. 7 presents enlarged view of FIG. 5, zooming up part showing a module structure of an analytical layer and access interface.

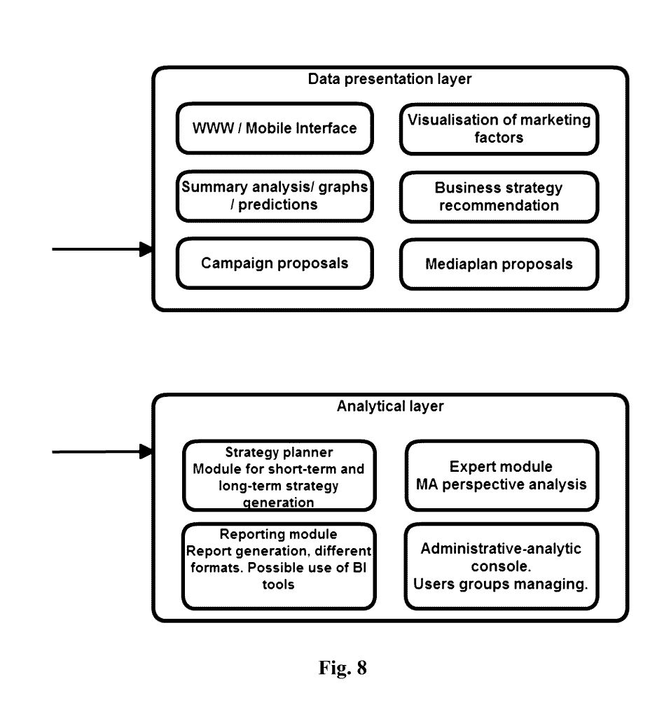

FIG. 8 presents enlarged view of FIG. 5, zooming up part showing a structure of an analytical module and data displaying module.

System structure assumes presence of 4 basic layers. First of them is a raw data layer which are processed in adapters. Next, so called a data gathering layer, allows to obtain an integrated analytical database. The data in a third layer are used by analytical modules and are processed creating an analytical results layer (in a meta format). Data obtained in this way are presented in a data presentation module, which is parameterized in terms of country, currency, adopted scheme etc.

It is worth noting that in every country acquired telemetric data, data about audience or television data (schedules, channels etc.) will be different. To deal with this problem different technologies are used within the framework of this system.

Adapter series (adapters depend on formats of input raw data) allow to process data and create one data metastructure described for each country. In this way an integrated analytic database is constructed, creating cloud on which analytic operations will be performed.

In the scope of the next layer integrated data undergo analytical operations in analytical modules to create a layer of analytical results. Data obtained as a result of analytical operations on integrated database for analysis form the basis for data presentation module. After specific parameterization (in terms of country, currency, scheme) data acquired in the analytic results layer are adapted and presented to the user in a form of an innovative graphic user interface.

Graphic User Interface (GUI), and hence data presenting method, was designed according to User Experience (UX) rules. For this purpose industrial design presented in this documentation and graphs or other graphic forms of data presentation are used. As a result “raw” data coming from different sources are processed to meta format, and subsequently after performing analytical operations and appropriate parameterization and adaptation depending on requirements of a target group, can be used to present results in a user-friendly way.

The presented system structure enables generation of integrated analytical database (from different sources and for different countries), which will be analyzed within analytical modules to create a results' layer. These are further adapted and presented in presentation layer available for user (graphic interface of the application user).

Simultaneously, the system is designed to differentiate user groups depending on held authorization. First, system users and administrators which coordinate system performance are indicated.

In a system user group 3 basic groups should be distinguished:
Analytics group—has a parameterized access to analytical tools, allowing for semi-independent construction of analytical models;
End user group—has an access to results of specified data and to the cyclic periodical reports.
User public group—“wandering” profiles sent periodically from each country.

Each individual layers of the solution are presented in the Figures.

In the data storage layer it is preferable to distinguish two crucial components:

DataStax Enterprise Cassandra—engine in Apache Cassandra technology which was chosen after precise analysis of available data storage methods in Big Data and noSQL field. This technology provides easy scalability of all architecture, workflow and access to data even in case of node failure, very fast data reading in case of proper design of tables structure. Database engine itself was adapted by DataStax company, which developed number of tools and solutions which facilitate functioning of the database and its management. Additional solutions allow to create tables in RAM memory (for even faster access to data), enable integration with Solr browser (Lucene), support full integration through special connector for analytical tool Spark and direct access to Cassandra tables.

In the project, no later than in the stage of raw data import to the database, initial data cleaning is performed, partial data denormalization occurs and consequently data redundancy, what is normal for Cassandra work model and conforms to recommendations. Initial integration of data proceeds also on the intra-schematic level as well as on a general level.

MSSQL/Oracle—standard, relational database, used everywhere where usage of noSQL database is not recommended or incompatible with its purpose. In this case it will be used for storage of user profiles, authorization or dictionary data which are not directly related with marketing data.

In the prediction layer/prediction analysis the following components can be specified:
1. Spark/Machine Learning—Apache Spark enables performance of different type of calculations in parallel environment. It enables data reading from many text formats, databases such as Cassandra or file systems such as Hadoop File System. Thanks to automatic parallelization of the processes and without user interference most optimal load distribution on available nodes in a computing cluster is achieved. Scripts launched in an environment with appropriate hardware parameters are characterized by robust results generation even on big data sets (full support for BigData), enable building advanced aggregates or multidimensional tables. Spark Job Server software complements functionality of Spark itself through adding, deleting or managing Spark multiple task queue. It provides comfortable “interface” for implementing computing tasks on Spark server. The engine itself supports preparation of applications in languages such as Scala, Java and Python with particular emphasis on Scala language. Mlib library (Machine Learning Library) is a functionality introduced in latest Spark versions. It is a library of most common machine learning algorithms and tools which support processes of classification, regressions, k-means or optimization using a gradient method.
2. Predictive models—predictive models are a starting point for implementation of solutions supporting prediction of such elements from marketing field as programming schedules, price lists or distribution of audience in time/on particular channels.
3. Apache Mahout—is a machine learning library directly integrated and containing full support in DataStax environment complementing functionality of the Mlib library.
4. .NET/C# toolkit—software for prediction of multiple marketing elements will be created based on existing solutions, simultaneously will be optimized and supplemented with new functionalities. In a final version it will make a full framework and one of the most important analytical tool in the system.

The access interface preferably comprises the following elements which enable rapid data processing:
1. ODBC/JDBC—drivers of this type give access to data stored in a Cassandra cluster from a multiple tools level including analytical ones of BI type. After driver installation into the system and after proper configuration it is possible to load and modify data directly from database engine. These drivers enable direct connection to Spark server and performance of complicated inquiries/aggregations using Spark mechanism.
2. Cassandra Connector—a driver specifically released by DataStax company to provide full access and native support with full load and save speed for Cassandra database. Available for Windows platform in 32 and 64 bits version after installation offers full support for BI tools of Power BI type or Tableau.
3. Oracle/MSSQL Connector—proper connectors are available both for .Net as well as Java environments. They provide trouble-free access to the data stored in relational databases.

Preferably, the presentation layer consists of:
1. WWW/Mobile interface;
2. Visualization of marketing factors;
3. Summary analyses/graphs/predictions;
4. Business strategy recommendation
5. Campaign proposals;
6. Media plan proposals.

Preferably in the analytical layer the following elements can be introduced:
1. Strategy planner—a module for short-term and long-term strategy generation.
2. Expert module—performing prescriptive analysis answering to questions and offering solutions.
3. Reporting module—generating reports and sharing them in different formats, interpreted also by tools such as Power Bi or Tableau.
4. Administrative-analytical console
enabling managing users and groups, defining security rights and rights to perform specific functions in the system, logging events and preview of currently operating analytical-predictive tasks.

1. A data processing system, especially data coming from a vast geographical territory, comprising the following components:
a. Means for acquiring telemetric data,
b. Adapters for initial processing of raw data,
c. Analytical modules,
d. Access interface,
e. User interface,
characterized in that it has a common, central and integrated database.

2. The data processing system according to claim 1 characterized in that the central integrated database operates on the basis of noSQL type of structures and typically relational MSSQL/ORACLE type of structures.

3. The data processing system according to claim 1 or 2 characterized in that the integrated database processing significant amounts of data, comprises an advanced database engine adapted to a fast support of extended structures, e.g. Cassandra type.

4. The data processing system according to claim 1, 2 or 3 characterized in that analytical modules processing information contained in the centrally integrated database operate in a Cloud computing technology.

5. The data processing system according to any of the preceding claims 1 to 4 characterized in that the analytical modules comprise modules for predictive computing and modules for descriptive computing, of which work is coordinated by a computing engine able to perform parallel computing and comprising algorithm bases for machine learning e.g. Spark type engine.

6. The data processing system according to any of the preceding claims 1 to 5 characterized in that the analytical modules comprise drivers necessary to allow communication between data stored in noSQL and MSSQL/ORACLE type databases.

7. The data processing system according to any of the preceding claims 1 to 6 characterized in that it has an user interface, which is a graphic interface developed according to User Experience (UX) rules.

8. The data processing method, especially data coming from a geographically vast territory, in the system according to any of the preceding claims 1 to 7 according to which:
a) telemetric data, especially those about audience, programming schedules, are acquired by means of telemetric data acquirement,
b) data acquired in this way are processed in adapters, wherein initial data cleaning and their partial denormalization is performed with redundancy achievement,
c) initially processed data are gathered and sorted in the central database.
d) data from the central database are subsequently subjected to integration and descriptive analysis, resulting in coherent information packages related to e.g. programming schedules, viewer demographic profile, advertisements costs, which are also saved in the database,
e) further data processing is performed based on user inquiries provided through and processed by a user interface.
f) data necessary to sustain user inquiries provided through the access interface are analyzed in analytical modules,
g) analysis results are transferred through the access interface to the user interface, which displays data in appropriate forms through an electronic device used.

9. The data processing method according to claim 8, wherein analytical modules use available computational resources in optimal way by performing parallel computing coordinated by appropriate software with machine learning functions e.g. Spark type.

10. The data processing method according to claim 8 or 9, wherein integrated database and analytical modules function in a Cloud computing technology.

11. The data processing method according to the claim 8, 9 or 10, wherein data corresponding to the user enquiries transmitted through the access interface to the user interface are parameterized according to user settings, such as country, currency, scheme.

12. The data processing method according to the claim 8, 9, 10 or 11, wherein the access interface providing communication between the user interface, analytical modules and the central database use drivers such as ODBC/JDBC, Cassandra Connector, ORACLE, MSSQL Connector, allowing fast communication between environments with different data formats.

13. A market data processing method according to the any of the preceding claims 8 to 12, wherein entering and displaying query results are performed using a graphic user interface, preferably maintained by PCs, laptops, tablets and/or smartphones.
